(19) United States
(12) Patent Application Publication
(10) Pub. No.: US 2026/0236530 A1
(43) Pub. Date: Aug. 13, 2026

(54) SYSTEM ARCHITECTURE FOR LIVE USER INTERACTION DURING VIDEO PLAYBACK

(71) Applicant: SAMSUNG ELECTRONICS, CO., LTD., Gyeonggi-Do (KR)

(72) Inventor: Seongnam Oh, Irvine, CA (US)

(21) Appl. No.: 19/359,250

(22) Filed: Oct. 15, 2025

Related U.S. Application Data
(60) Provisional application No. 63/757,678, filed on Feb. 12, 2025.

(51) Int. Cl. G06F 16/73; G06V 10/77

(52) U.S. Cl. CPC G06F 16/73; G06V 10/7715

(57) ABSTRACT

A system architecture for live user interaction during video playback is capable of detecting one or more visual objects in a video concurrently with playing the video on a screen of a device. The visual objects are stored within a physical memory of the device. The visual objects are discarded from the physical memory after a predetermined window of time. In response to receiving an input from a user specifying a user query, the visual objects stored in the physical memory are searched for a match to the user query. In response to matching a selected visual object from the physical memory with the user query, the selected visual object is submitted with the user query to a large language model system. A result from the large language model system is provided to the user.

### CROSS-REFERENCE TO RELATED APPLICATIONS

This application claims the benefit of U.S. Application Number 63/757,678 filed on February 12, 2025, which is fully incorporated herein by reference.

### TECHNICAL FIELD

This disclosure relates to a system architecture that supports live user interaction with video playback based on object detection and large language model technology.

### BACKGROUND

Artificial Intelligence (AI)-based services can be provided on different types of devices. Some devices, such as smart phones, can have a very efficient interaction mechanism between the device and human, e.g., user. For example, smart phones typically have touch-sensitive screens that allow a user to interact with the device via a touch-based user interface. Through the touch-sensitive screen, a user may interact with the device using fingers, stylus pen, etc., to convey user intent. As an example, a user is able to point out or select items of interest presented on the screen. To do so, the user may pause or freeze playback of a video and circle a desired area of the frozen/paused video or image to encompass the desired item thereby selecting or choosing the item as an input to an AI-based service.

Other types of devices lack an effective communication mechanism that allows a user to interact with the device and convey user intent. For example, devices such as digital televisions (DTVs) or other real-time playback systems may lack features such as touch-sensitive screens and/or playback control over content. The devices may continuously playback video without the ability to pause or freeze video during playback. Unlike the smart phone example, the user is unable to interact with the device using a touch-based user interface to select particular objects of interest that are displayed on the screen of the device, particularly in the context of the device playing and/or displaying a video.

### SUMMARY

In one or more examples, a method includes detecting visual objects (e.g., one or more visual objects) in a video concurrently with playing the video on a screen of a device. The method includes storing the visual objects within a physical memory of the device and discarding the visual objects from the physical memory after a predetermined window of time. The method includes, in response to receiving an input from a user specifying a user query, searching the visual objects stored in the physical memory for a match to the user query. The method includes, in response to matching a selected visual object from the physical memory with the user query, submitting the selected visual object with the user query to a large language model system. The method includes providing a result from the large language model system to the user.

In one or more examples, a device includes a screen and a video player capable of playing a video on the screen. The device includes a vision object analyzer capable of detecting visual objects (e.g., one or more visual objects) in the video concurrently with the video playing on the screen. The device includes a detected object manager capable of storing the visual objects within a physical memory of the device. The detected object manager is further capable of discarding the visual objects from the physical memory after a predetermined window of time. The device includes an image search manager that, in response to receiving an input from a user specifying a user query, is capable of searching the visual objects stored in the physical memory for a match to the user query, matching a selected visual object from the physical memory with the user query, and submitting the selected visual object with the user query to a large language model system. The device includes a user interaction manager capable of receiving the input and providing a result from the large language model system to the user.

In one or more examples, a device includes a screen, a physical memory, and a hardware processor capable of performing operations. The operations include detecting visual objects (e.g., one or more visual objects) in a video concurrently with playing the video on the screen of the device. The operations include storing the visual objects within a physical memory of the device and discarding the visual objects from the physical memory after a predetermined window of time. The operations include, in response to receiving an input from a user specifying a user query, searching the visual objects stored in the physical memory for a match to the user query. The operations include, in response to matching a selected visual object from the physical memory with the user query, submitting the selected visual object with the user query to a large language model system. The operations include providing a result from the large language model system to the user.

In one or more examples, a computer program product includes a computer readable storage medium having program instructions stored thereon. The program instructions are executable by a hardware processor to perform the various operations described within this disclosure.

This Summary section is provided merely to introduce certain concepts and not to identify any key or essential features of the claimed subject matter. Many other features and embodiments of the disclosed technology will be apparent from the accompanying drawings and from the following detailed description.

### BRIEF DESCRIPTION OF THE DRAWINGS

The accompanying drawings show one or more embodiments; however, the accompanying drawings should not be taken to limit the disclosed technology to only the embodiments shown. Various aspects and advantages will become apparent upon review of the following detailed description and upon reference to the drawings.

FIG. 1 illustrates an example video processing architecture.

FIG. 2 illustrates an example method of operation for the video processing architecture of FIG. 1.

FIG. 3 illustrates an example of a frame of video that has been processed by a vision object analyzer.

FIG. 4 illustrates an example of data including detected visual objects that may be stored in the visual object memory.

FIG. 5 is an example of a device that may include the video processing architecture of FIG. 1.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to a system architecture that supports live user interaction with video playback based on object detection and large language model technology. For certain types of devices that lack features such as a touch-based user interface (e.g., a touch-sensitive screen), available user interaction techniques employed by devices such as smart phones are unavailable. A device that lacks a touch-based user interface may be referred to as a “touchless” or “touch-free” device. A touchless device may include other controls (e.g., buttons, knobs, etc.) that a user may operate, but is characterized by the inclusion of a screen that is not touch-enabled. Touchless devices and/or other devices may also lack the ability to control playback of content such as video. Still, users often have a need to interact with these devices to convey a particular user intent. For example, users may wish to invoke certain services including Artificial Intelligence (AI)-based image search or other AI-based services. Without an effective touchless user interface through which the user may convey intent to the device, the user is often unable to effectively interact with the touchless device and/or invoke desired functionality.

As an illustrative and non-limiting example, a user may wish to perform an image search while viewing content on a device such as a Digital Television (DTV) or other real-time playback system. As noted, such devices are often touchless devices in that the devices lack a touch-sensitive screen. Such devices typically lack the ability to pause or freeze playback of content such as video. In some cases, for example, the devices may be playing back content such as a real-time broadcast content or real-time over-the-top (OTT) streaming that is not stoppable. In these situations, the systems are unable to support features such as image search. The user is unable to convey an intent to the device that selects an object displayed on the screen of the device during playing or playback of video to initiate an image search of that object. Currently available speech user interfaces do not support such operations. Even in cases where the content playback may be controlled, e.g., paused, available speech-based user interfaces lack the capability to capture user intent, particularly user intent directed to video content being played by the device.

The disclosed technology provides a system architecture, which may be embodied as methods, systems, devices, and/or and computer program products, that supports touchless interaction between a user a device. The system architecture is capable of capturing user intent through various touchless mechanisms, e.g., a touchless user interface, to invoke various services including AI-based services.

In one or more examples, the system architecture is capable of utilizing technologies such as object detection to identify or detect one or more visual objects within video being played by a device. The system architecture is capable of storing the visual objects for a limited amount of time. As the device may lack both a touch-sensitive screen and the ability to pause playback of the content, the detection of visual objects and storage of such visual objects for a limited time allows the user to issue queries to the device in real-time. The system architecture is capable of storing visual objects detected from frames of video that have been displayed and/or retrieving these past visual objects from storage based on user submitted queries.

The disclosed technology allows a user to query the device for additional information about a particular object that was displayed by the device within a window of time preceding the query. As a user watches content and sees a particular object of interest, the user may query the device for information about the object(s). So long as that object was recognized/detected by the system architecture and still resides in physical memory of the device when the user query is submitted or executed, the system architecture is capable of matching the user query to the object of interest and obtaining additional information about the object that can be delivered to the user.

In some aspects, the disclosed technology provides a content storage and retrieval architecture for a System-on-Chip (SoC) including a visual object detector and a tracking mechanism based on a language-based AI engine. The architecture is configured to, in response to detecting a visual object within a frame of video, derive metadata, e.g., a type or label, for the visual object without first performing an image search based on the visual object. In some aspects, the disclosed technology provides a buffering mechanism capable of storing one or more visual objects detected in one or more past frames of video to retrieve information about the one or more detected visual objects for a user at a current time (e.g., in response to a user query to do so).

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

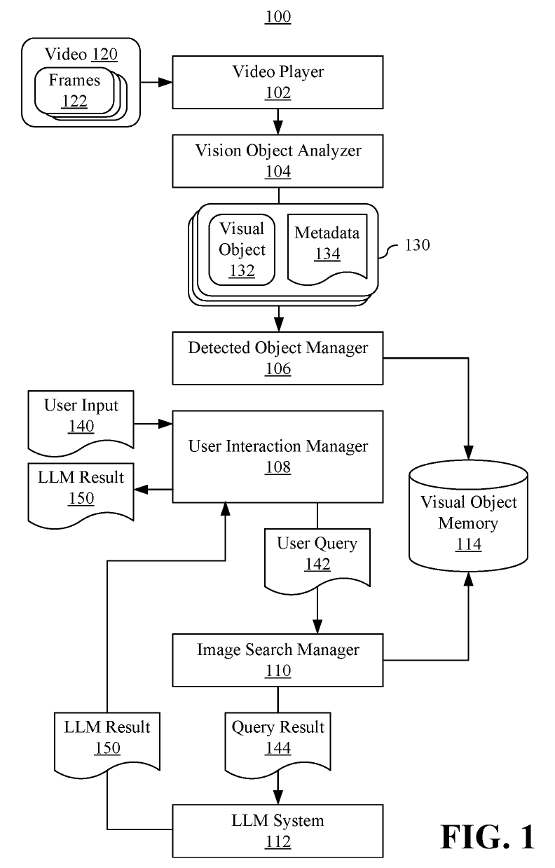

FIG. 1 illustrates an example video processing architecture 100. Video processing architecture 100 is capable of supporting live user interactions based on object detection and large language model technology.

In one or more examples, video processing architecture 100 is implemented as an executable architecture, e.g., program code, that may be executed by one or more hardware processors (e.g., central processing units (CPUs) and/or hardware accelerators) of a data processing system. In one or more other examples, video processing architecture 100 is implemented as an electronic system that may include a plurality of interconnected circuits as represented by the various blocks of FIG. 1, whether contained in a same integrated circuit (IC) device or implemented in a plurality of IC devices. The IC device(s), which may include hardware processors, may be configured to perform the various operations described herein. Examples of the IC devices may include, but are not limited to, Application-Specific ICs (ASICs), programmable IC devices (e.g., field programmable gate arrays or “FPGAs”), graphics processing unit(s) (GPUs), digital signal processing units (DSPs), neural processors, Systems-on-Chip, hardware accelerators, and/or any combination of the foregoing.

In one or more examples, video processing architecture 100 may be implemented as, or included within (e.g., embedded within), a workstation, a desktop computer, a computer terminal, a mobile computer, a laptop computer, a netbook computer, a tablet computer, a smart phone, a personal digital assistant, a smart watch, smart glasses, a gaming device, a set-top box, a television, a smart television, information appliance, streaming device, IoT device, server, a virtual reality (VR) system, an augmented reality (AR) system, a mixed reality (MR) system, an extended reality (XR) system, a metaverse system, a wearable device (e.g., smart glasses and/or goggles), or the like.

While video processing architecture 100 may be implemented or embedded in any of a variety of different types of systems, video processing architecture 100 may be particularly suited for use in systems that lack a touch-sensitive screen. That is, the system uses or has a non-touch-enabled screen that prevents a user from using touch as an input mechanism for selecting content such as objects that may be displayed on the screen. In this regard, video processing architecture 100 may be said to be a “touchless system.” Video processing architecture 100 may also be suited for implementation in systems such as digital televisions (DTVs) or other real-time playback systems where the ability to pause a video being played or rendered is limited to non-existent.

Video processing architecture 100 can include a video player 102, a vision object analyzer 104, a detected object manager 106, a user interaction manager 108, an image search manager 110, a large language model (LLM) system 112, and a visual object memory 114. In the examples described herein, video processing architecture 100 may operate in real-time or in substantially real-time. In some examples, all of the various functions and/or subsystems illustrated in FIG. 1 may be implemented locally within the particular system/device in which video processing architecture 100 is embedded, whether in a multi-processor data processing system, an SoC, or the like.

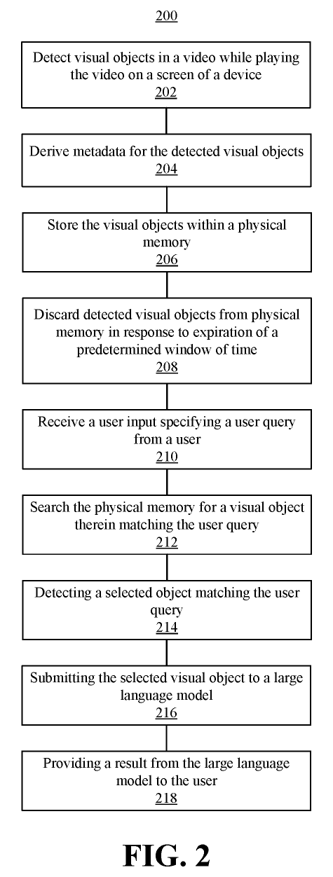

FIG. 2 illustrates an example method 200 of operation for video processing architecture 100 of FIG. 1. Referring to FIGS. 1 and 2 in combination, video processing architecture 100 is capable of receiving a video 120. Video 120 includes a plurality of sequential or time ordered frames 122. Each frame 122, for example, may be considered a digital image.

In block 202, vision object analyzer 104 is capable of detecting visual objects while video player 102 plays video 120 on a screen of a device in which video processing architecture 100 is implemented or embedded. In the example, video player 102 plays video 120 on a screen of the device and passes the video through to vision object analyzer 104. Vision object analyzer 104 may be configured to detect particular types of visual objects within individual frames 122 of video 120. Vision object analyzer 104 may detect the visual objects within frames 122 in real-time or in substantially real-time.

In the example of FIG. 1, vision object analyzer 104 is capable of performing a variety of different operations. These operations may be performed on frames as the frames are displayed or subsequent to display of the frame. For example, for a received image, such as a frame 122 or for each frame 122 of video 120, vision object analyzer 104 is capable of detecting whether particular visual objects are present within the frame. Vision object analyzer 104 may be configured or trained to detect one or more different types of objects from frames of video.

Vision object analyzer 104 is also capable of localizing the visual objects that are detected within the respective frames. For example, vision object analyzer 104 is capable of segmenting the frame using bounding boxes or other techniques such as masks to detect a location of each detected object within the frame thereby providing a spatial relationship between the visual objects detected within each respective frame 122. Vision object analyzer 104 is also capable of classifying each visual object detected by assigning one or more labels to each visual object detected. Further, the vision object analyzer 104 is capable of tracking the visual objects from one frame 122 of video 120 to the next.

Vision object analyzer 104 may be implemented using any of a variety of different object detection technologies. For example, vision object analyzer 104 may be implemented as a feature-based detector, as a deep learning-based detector such as a Region-Based Convolutional Neural Network (CNN), a Fast Recurrent-CNN (CNN), a You Only Look Once (YOLO) detector, or as a Single Shot MultiBox Detector (SSD), or as an instance segmentation model such as Mask R-CNN. The examples provided herein are for purposes of illustration and not limitation. Vision object analyzer 104 may be implemented using one or more or a combination of the aforementioned technologies to implement functions such as visual object detection, localization, labeling, and/or tracking.

As illustrated in FIG. 1, visual object analyzer 104 is capable of outputting dataset(s) 130 for frames 122 of video 120. Each dataset 130 corresponds to a detected visual object. For example, each dataset 130 can include a visual object 132 and metadata 134 for the visual object 132. Appreciably, visual object analyzer 104 may output a plurality of such datasets, e.g., one dataset for each visual object detected in a given frame of video or no datasets for a given frame in cases where no visual objects are detected in the frame. In the example, visual object analyzer 104 is capable of segmenting each frame based on the bounding boxes surrounding the detected objects of the frame. For each frame, the segment (e.g., portion of the frame defined by the bounding box) including a detected object is extracted (e.g., separated or copied from the frame). In this regard, each segment is a cropped portion of the original frame (e.g., a cropped image) such that the segment of the frame includes the detected visual object. Each detected visual object (e.g., segment) as extracted may be stored independently of the frame from which the segment was extracted.

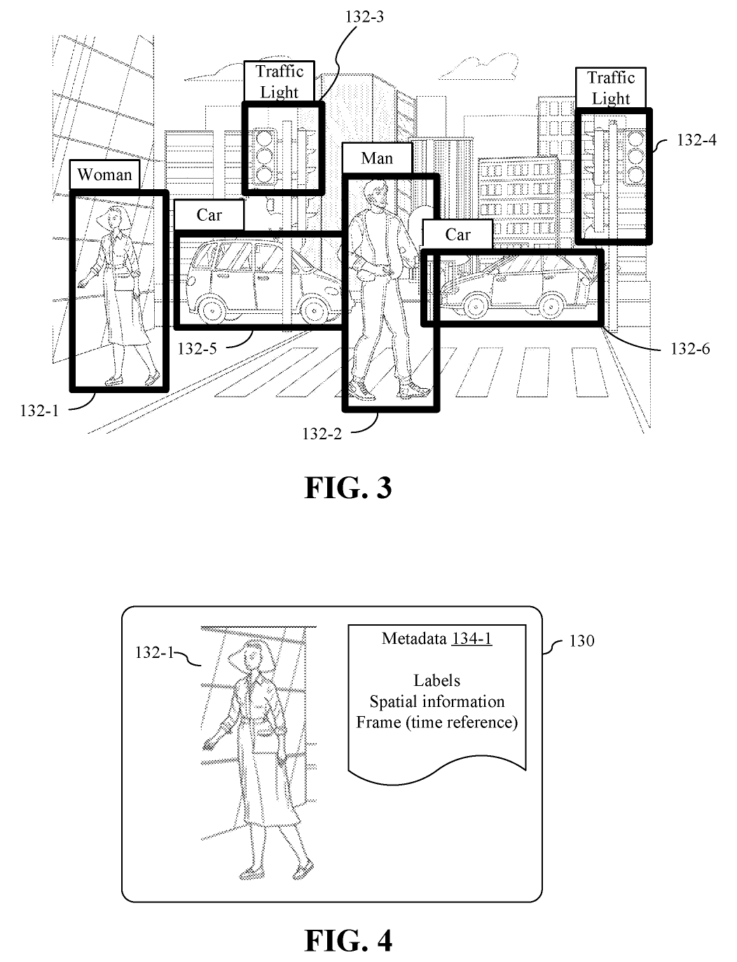

FIG. 3 illustrates an example of a frame of video that has been processed by vision object analyzer 104. In the example, vision object analyzer 104 has detected a plurality of different objects. In the example, each detected visual object is indicated by a bounding box surrounding or encompassing the detected visual object. For example, vision object analyzer 104 has detected visual objects 132-1, 132-2, 132-3, 132-4, 132-5, and 132-6.

In block 204, visual object analyzer 104 is capable of deriving metadata for the detected visual objects. Referring again to the example of FIG. 3, vision object analyzer 104 has not only detected the visual objects, but also has derived metadata. For example, vision object analyzer 104 has derived labels based upon how the various visual objects have been recognized or classified. Visual objects 132-1 and 132-2 are recognized as human beings. Vision object analyzer 104 has recognized visual object 132-1 as a woman and visual object 132-2 as a man. Vision object analyzer 104 has recognized visual objects 132-3 and 132-4 as traffic lights. Vision object analyzer 104 has recognized visual objects 132-4 and 132-6 as cars. In the example, the terms “traffic light,” “car,” “woman,” and “man” are labels applied to the respective visual objects that indicate type of the detected visual objects.

The information derived for each detected object such as the localization information for the detected object, the label(s) of the detected object, and the particular frame from which the detected object was extracted and/or other time reference may be referred to as metadata 134 for visual object 132 in the example of FIG. 1. In one or more examples, each visual object 132, as provided from visual object analyzer 104 to detected object manager 106, may be a segment, which is the portion of the frame cropped along the borders of the bounding box of the detected visual object.

FIG. 4 illustrates an example of a dataset 130 for a detected visual object. In the example, visual object 132-1 is provided as a cropped version of the frame including the woman. Metadata 134-1 may include information such as labels (e.g., human, woman, etc.). It should be appreciated that the metadata may include additional information or labels for other information detected about the visual object such as color or actions/motion. In this case, the additional metadata may specify information such as color of clothing items, type of clothing items (e.g., dress, jacket, slacks, shoes, etc.), physical features such as hair color, motion such type of activity (e.g., walking, running, etc.), or the like. The spatial information of metadata 134-1 may specify the location of visual object 132-1 within the frame. The spatial information may be a coordinate location of the center of the bounding box, may specify corner information (e.g., coordinates of two opposing corners) for the bounding box, a quadrant of the frame in which the visual object was detected, or the like. A time reference may be generated. In some examples, the time reference may be the particular frame from which the visual object was detected. The frame may be specified as an identifier or using a time stamp. Appreciably, the frame may serve as a time reference given that the frames are played sequentially in time and also are to be played at a given frame rate.

In block 206, detected object manager 106 is capable of storing the datasets 130 within visual object memory 114. Visual object memory 114 may be implemented as a data structure within a physical memory of the system. Detected object manager 106 is capable of storing visual object, as extracted, with, e.g., in association with, the metadata for the segment as a dataset. The particular data structure used to store datasets may be any of a variety of different types of structures whether a database, a linked list, a table where datasets are stored as entries, or the like.

The particular operations described in connection with vision object analyzer 104 may be performed on a per-frame basis. Similarly, datasets generated from vision object analyzer 104 by way of the object detection performed may be stored by detected object manager 106 for the respective frames of video 120.

In block 208, detected object manager 106 is capable of discarding datasets from visual object memory 114. For example, detected object manager 106 may monitor visual object memory 114 and purge any datasets from visual object memory 114 after a predetermined amount of time, e.g., a window of time. In the example, in response to expiration of the window of time, detected object manager 106 is capable of discarding, or deleting, the dataset. In one or more examples, the window of time may be measured from the time reference of each respective dataset. As such, datasets of a particular age, as measured from the time reference, may be deleted from visual object memory 114.

In the example, video processing architecture 100 is configured to store a limited amount of data by restricting the amount of time that the detected visual objects are stored. The window of time may be set to an amount that allows a user watching a video to query video processing architecture 100 about objects that were displayed within the recent past. For purposes of illustration, the window of time may be set to approximately 3-5 minutes. Appreciably, the particular duration of the window of time may vary based on the amount of physical memory available to store datasets and the ability of the system to provide real-time or substantially real-time operation. In general, video processing architecture 100 is configured to respond to user queries pertaining to visual objects displayed on the screen of a device in the recent past. With a defined or predetermined window of time of 5 minutes, for example, the user is able to query video processing architecture 100 for any visual objects displayed on the screen of the device by video player 102 in the last 5 minutes so long as such visual objects were detected.

Continuing with FIG. 1, in block 210, user interaction manager 108 is capable of receiving an input from a user illustrated as user input 140. In one or more examples, user input 140 is a user spoken utterance, e.g., speech from a user. In this example, user interaction manager 108 is capable of performing speech recognition to convert the user spoken utterance into text. In some examples, user interaction manager 108 may include a natural language understanding processor that is capable of extracting semantic content or meaning from the speech recognized text.

In the example, video processing architecture 100 is capable of detecting the visual objects and deriving metadata for the visual objects continuously. Such actions are performed on frames of the video 120 independently of receipt and/or processing of any input specifying a user query. Processes such as detection of visual objects, derivation of metadata for the detected visual objects, the management of storage of datasets in visual object memory 114 (including purging), and the processing of inputs from a user may be performed independently of one another.

In one or more other examples, user input 140 may be a textual input with user interaction manager 108 receiving the textual input from a user device. For example, a user may utilize a smart phone or other device to type text as user input 140. User interaction manager 108 optionally may process the textual input through a natural language understanding processor to extract semantic content or meaning from the textual input. Whether user input 140 is received as text or as a user spoken utterance, video processing architecture 100 provides a touchless user interface for the user.

User input 140 may contain or specify a user query 142. User interaction manager 108 may submit user query 142 to image search manager 110. In one or more examples, user query 142 may include only the text specified by user input 140. In one or more other examples, user query 142 may be a combination of the text from the user input 140 in combination with semantic content derived from natural language understanding processing. In one or more other examples, user query 142 may include only the semantic content derived from natural language understanding processing of user input 140.

In block 212, image search manager 110 is capable of searching the physical memory for a visual object stored therein that matches user query 142. For example, image search manager 110 is capable of searching the datasets 130 stored in visual object memory 114 for a match to user query 142. In some examples, the search may be a keyword search that attempts to match keywords from user query 142 with metadata of datasets 130.

For purposes of illustration, consider an example in which the user is viewing video 120, e.g., a livestream, movie, or other streaming content, on a screen of a device and sees a particular object of interest such as a car. In response to seeing the car displayed while watching the video, the user may utter the phrase “what’s the car” as user input 140. In that case, user interaction manager 108 receives the user spoken utterance and generates user query 142. Image search manager 110 searches visual object memory 114 for a detected visual object stored therein matching the query. Given that visual object memory 114 only stores datasets for a limited period of time, the searching is inherently limited to those visual objects displayed in the window of time, which is the last 5 minutes of the video playback in this example.

If both cars corresponding to visual objects 132-5 and 132-6 still reside in visual object memory 114, image search manager 110 may retrieve the dataset for one or both of the visual objects. In one or more examples, image search manager 110 may apply one or more heuristics to differentiate between similar or same visual objects. In this example, image search manager 110, in response to detecting that more than one object matches user query 142, may select the particular visual object that is closer to the foreground.

In another example, user query 142 itself may include sufficient information to select one match over another. In that case, image search manager 110 may differentiate between objects of a same type (e.g., persons, cars, or other top-level tag or label of a tag/label hierarchy), based on metadata for the plurality of visual objects and the user query. For example, the user query 142 may say “what’s the car on the left” or “what’s the red car.” In the case of “what is the car on the left,” the spatial information from the user query may be used by image search manager 110 to search the metadata to distinguish between the two car visual objects. In the case of “what’s the red car,” the color information from the user query may be used by image search manager 110 to search the metadata and distinguish between the two car visual objects. In still other examples, image search manager 110 may select more than one visual object, e.g., each visual object, matching user query 142.

By storing detected visual objects and metadata for a window of time that spans multiple different frames of video, the disclosed technology goes beyond the capabilities of systems that only work with the current frame of video being displayed. Further, by virtue of storing data for a limited time, e.g., the window of time, the searching is effectively filtered on a temporal basis to search for data relating to a limited number of past, e.g., previously displayed, frames of video.

Accordingly, in block 214, image search manager 110 detects a selected visual object matching user query 142. In block 216, image search manager 110 provides the selected visual object, e.g., the dataset 130 for the selected visual object (e.g., the selected visual object as a segment and the associated metadata), to LLM system 112 as query result 144.

In one or more examples, image search manager 110 may formulate query result 144 to include the dataset of the matching visual object (the visual object and its metadata). In other examples, image search manager 110 may formulate query result 144 to include the dataset and text of user input 140. In other examples, image search manager 110 may formulate query result 144 to include the dataset, the text of user input 140, and any semantic information generated/derived from the text of user input 140. Thus, in the example, LLM system 112 may not only receive dataset 130 for the matching visual object, but also the user input responsible for generating the matching visual object. In this example, query result 144 may include the dataset of the matching detected visual object as well as “what’s the car.”

LLM system 112 is capable of understanding the user’s intention as to query result 144. In one or more examples, LLM system 112 may be a locally executed or operated system. That is, LLM system 112 may execute or reside within the particular system or device in which video processing architecture 100 is embedded. LLM system 112 is capable of performing inference on query result 144. Because query result 144 will include multimodal information, e.g., both textual information (e.g., metadata, text of the user input, and/or semantic information) and visual information (the visual object), LLM system 112 may be implemented as a mixed-mode LLM in that LLM system 112 may receive both text and images as input. LLM system 112 performs inference based on received query result 144.

In block 218, the inference result generated by LLM system 112 in response to query result 144 illustrated as LLM result 150 is provided back to user interaction manager 108. User interaction manager 108, in response to receiving LLM result 150 from LLM system 112, is capable of providing LLM result 150 to the user and/or to a user device.

In one or more examples, LLM result 150 may be provided to the user in the form of audio. For example, user interaction manager 108 may include a text-to-speech engine that is capable of generating computer-based speech/audio specifying the text of LLM result 150. In one or more other examples, LLM result 150 may be displayed on the screen of the device in which video processing architecture 100 is embedded. For example, the text and/or any images of LLM result 150 may be displayed as a visual overlay atop of playback of video 120.

Referring to the prior example where the user input specified “what’s the car,” the LLM result 150 may state “it is a <year1> <make1> <model1> and <year2> <make2> <model2>. The <year1> <make1> <model1> come equipped with <features>. The <year2> <make2> <model2> come equipped with <features>.” In the example, both visual objects 132-5 and 132-6 were found to match user query 142 and were submitted to LLM system 112. As noted, in other cases, for example, where the user provides additional information that allows the system to differentiate between same and/or similarly labeled visual objects, image search manager 110 may select the particular visual object that most closely matches user query 142.

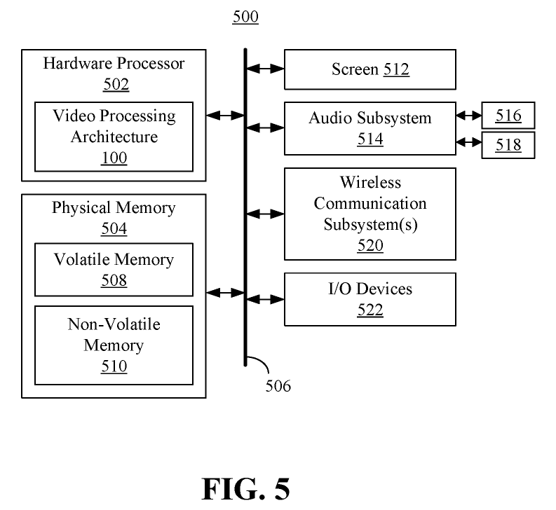

FIG. 5 is an example of a device 500 that may include video processing architecture 100 of FIG. 1. Examples of device 500 may include a workstation, a desktop computer, a computer terminal, a mobile computer, a laptop computer, a netbook computer, a tablet computer, a smart phone, a personal digital assistant, a smart watch, smart glasses, a gaming device, a set-top box, a television (e.g., a digital television or DTV), a real-time playback system, a smart television, information appliance, streaming device coupled to a device having a screen, IoT device, server, a virtual reality (VR) system, an augmented reality (AR) system, a mixed reality (MR) system, an extended reality (XR) system, a metaverse system, a wearable device (e.g., smart glasses and/or goggles), or the like.

As noted, while video processing architecture 100 may be implemented in any of a variety of different types of devices including both touch-enabled and touchless devices, video processing architecture 100 may be particularly suited for implemented in a touchless device to provide touch-free interaction between the device and a user.

In the example, device 500 includes one or more hardware processors 502. In one or more examples, hardware processor 502 may be embodied as a central processing unit (CPU) that includes one or more cores, where each core is capable of executing computer-readable program instructions. Hardware processor 502 may be implemented using any of a variety of architectures such as, for example, a complex instruction set computer architecture (CISC), a reduced instruction set computer architecture (RISC), a vector processing architecture, or other known architectures. For example, a hardware processor may be implemented using an x86 architecture (e.g., IA-32, IA-64), a Power Architecture, as an ARM processor, or the like. Though not illustrated, hardware processor 502 also may include one or more hardware accelerators. Examples of hardware accelerators may include, but are not limited to, GPUs, DSPs, SoCs, FPGAs, ASICs, or the like.

In one or more other examples, hardware processor 502 may be implemented as an SoC that is capable of implementing the various blocks of video processing architecture 100 of FIG. 1 as hardware blocks (e.g., application-specific circuit blocks). In one or more other examples, hardware processor 502 may be implemented as a combination of application-specific circuit blocks and/or cores capable of executing program code. In any case, video processing architecture 100 is capable of performing the operations described herein while, or concurrently with, playing received video 120, e.g., digital video, on screen 512 and outputting audio from video 120 to audio subsystem 514 for playback through speaker 516.

Hardware processor 502 is coupled to a physical memory 504 via interconnect circuitry 506. Physical memory 504 may be embodied as one or more computer-readable storage mediums. Physical memory 504 may include a volatile memory 508 and a non-volatile memory 510. Volatile memory 508 may be embodied as random-access memory (RAM) and may include cache memory. Non-volatile memory 510 may include a non-volatile magnetic medium and/or a solid-state medium.

In some example implementations, non-volatile memory 510 may include one or more disk drives capable of reading from and writing to various types of removable, non-volatile mediums such as a removable, non-volatile magnetic disk (e.g., a "floppy disk") and/or a removable, non-volatile optical disk such as a CD-ROM, DVD-ROM or other optical media.

Examples of interconnect circuitry 506 include, but are not limited to, an input/output (I/O) subsystem, an I/O interface, a communication bus, and a memory interface. For example, interconnect circuitry 506 may be implemented as any of a variety of communication bus structures and/or combinations of communication bus structures including a memory bus or memory controller, a peripheral bus, a Peripheral Component Interconnect Express (PCIe) bus, on-chip interconnect, an accelerated graphics port, and a processor or local bus.

Device 500 may include a screen 512. In one or more examples, screen 512 is a non-touch-enabled display device. In this regard, screen 512 is incapable of receiving touch or touch-based input from a user. Video received by device 500, e.g., a digital video stream, may be rendered or displayed on screen 512.

Device 500 may include an audio subsystem 514. Audio subsystem 514 can be coupled to interconnect circuitry 506 directly or through a suitable input/output (I/O) controller. Audio subsystem 514 can be coupled to a speaker 516 and a microphone 518 to facilitate voice-enabled functions such as receiving user input 140 as a user spoken utterance via microphone 518 and playing audio content including audio generated from text specified by LLM result 150 through speaker 516.

Device 500 may include one or more wireless communication subsystems 520. Each of wireless communication subsystem(s) 520 can be coupled to interconnect circuitry 506 directly or through a suitable I/O controller (not shown). Each of wireless communication subsystem(s) 520 is capable of facilitating communication functions. Examples of wireless communication subsystems 520 can include, but are not limited to, radio frequency receivers and transmitters, and optical (e.g., infrared) receivers and transmitters. The specific design and implementation of wireless communication subsystem 520 can depend on the particular type of device 500 implemented and/or the communication network(s) over which device 500 is intended to operate. In one or more examples, device 500 may receive digital video via one or more of wireless communication subsystems 520. In one or more other examples, user input 140 specifying text input from a user device coupled to device 500, whether wired or wirelessly, may be received via subsystem(s) 520.

Device 500 further may include one or more other input/output (I/O) devices 522 coupled to interconnect circuitry 506. I/O devices 522 may be coupled to device 500, e.g., interconnect circuitry 506, either directly or through intervening I/O controllers (not shown). Examples of I/O devices 522 include, but are not limited to, a keyboard, one or more communication ports (e.g., Universal Serial Bus (USB) ports), a network adapter, and buttons or other physical controls.

A network adapter refers to circuitry that enables device 500 to become coupled to other systems, computer systems, remote printers, and/or remote storage devices through intervening private or public networks. Modems, cable modems, Ethernet interfaces, and are examples of different types of network adapters that may be used with device 500.

Device 500 is capable of supporting multiple different communication channels with a user whether by way of a user device coupled to device 500 or using audio subsystem 514.

Device 500 is provided an example of an electronic device or system that is capable of performing the various operations described within this disclosure and is not intended to be limiting. A device and/or system configured to perform the operations described herein may have a different architecture than illustrated in FIG. 5. The architecture may be a simplified version of the architecture described in connection with FIG. 5 or may be a more complex version of the architecture described in connection with FIG. 5. In this regard, device 500 may include fewer components than shown or additional components not illustrated in FIG. 5 depending upon the particular type of device that is implemented.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise.

As defined herein, the term “automatically” means without user intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of computer readable storage mediums. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the term "hardware processor" means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), an SoC, programmable logic circuitry, a controller, and a Graphics Processing Unit (GPU).

As defined herein, the term "real-time" means a level of processing responsiveness that a user or system senses as sufficiently immediate for a particular process or determination to be made, or that enables the processor to keep up with some external process.

As defined herein, the terms “in response to” and “responsive to” mean responding or reacting readily to an action or event. Thus, if a second action is performed “in response to” or “responsive to” a first action, there is a causal relationship between an occurrence of the first action and an occurrence of the second action. The term "responsive to" indicates the causal relationship. In some cases, other terms such as “if,” “when,” or “upon” are used and also convey a causal relationship.

The term "substantially" means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or two or more, e.g., a plurality, of such mediums) having computer readable program instructions thereon for causing a processor to carry out aspects of the present disclosed technology. Within this disclosure, the term “program code” is used interchangeably with the terms “computer readable program instructions” and “program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

The description of the disclosed technology provided herein is for purposes of illustration and is not intended to be exhaustive or limited to the form and examples disclosed. The terminology used herein was chosen to explain the principles of the disclosed technology, the practical application or technical improvement over technologies found in the marketplace, and/or to enable others of ordinary skill in the art to understand the disclosed technology. Modifications and variations may be apparent to those of ordinary skill in the art without departing from the scope and spirit of the disclosed technology. Accordingly, reference should be made to the following claims, rather than to the foregoing disclosure, as indicating the scope of such features and implementations.

What is claimed is:

1. A method, comprising:
detecting visual objects in a video concurrently with playing the video on a screen of a device;
storing the visual objects within a physical memory of the device and discarding the visual objects from the physical memory after a predetermined window of time;
in response to receiving an input from a user specifying a user query, searching the visual objects stored in the physical memory for a match to the user query;
in response to matching a selected visual object from the physical memory with the user query, submitting the selected visual object with the user query to a large language model system; and
providing a result from the large language model system to the user.

2. The method of claim 1, wherein the video is received by the device in real-time and the screen of the device is incapable of detecting touch-based user input.

3. The method of claim 1, further comprising:
for each visual object detected in the video, deriving metadata for the visual object and storing the metadata in association with the visual object and a time reference for the visual object;
wherein the searching includes searching the metadata for the visual objects for a match to the user query.

4. The method of claim 1, further comprising:
differentiating between a plurality of visual objects of a same type based on metadata for the plurality of visual objects and the user query.

5. The method of claim 1, wherein the input is received as a user spoken utterance or as text.

6. The method of claim 1, wherein the result from the large language model system is provided to the user as audio.

7. The method of claim 1, wherein the result from the large language model system is displayed on the screen of the device.

8. The method of claim 1, wherein the detecting the visual objects is performed continuously on the video independently of the input specifying the user query.

9. The method of claim 1, wherein the visual objects stored in the physical memory have been displayed on the screen of the device.

10. A device, comprising:
a screen;
a video player capable of playing a video on the screen;
a vision object analyzer capable of detecting visual objects in the video concurrently with playing the video on the screen;
a detected object manager capable of storing the visual objects within a physical memory of the device and discarding the visual objects from the physical memory after a predetermined window of time;
an image search manager that, in response to receiving an input from a user specifying a user query, is capable of searching the visual objects stored in the physical memory for a match to a user query, matching a selected visual object from the physical memory with the user query, and submitting the selected visual object with the user query to a large language model system; and
a user interaction manager capable of receiving the input and providing a result from the large language model system to the user.

11. The device of claim 10, wherein the video is received by the device in real-time and the screen of the device is incapable of detecting touch-based user input.

12. The device of claim 10, wherein the vision object analyzer is capable of, for each visual object detected in the video, deriving metadata for the visual object;
wherein the detected object manager is capable of storing the metadata in association with the visual object and a time reference for the visual object; and
wherein the image search manager is capable of searching the metadata for the visual objects for a match to the user query.

13. The device of claim 10, wherein the image search manager is capable of differentiating between a plurality of visual objects of a same type based on metadata for the plurality of visual objects and the user query.

14. The device of claim 10, wherein the input is received as a user spoken utterance or as text.

15. The device of claim 10, wherein the result from the large language model system is provided to the user as audio.

16. The device of claim 10, wherein the result from the large language model system is displayed on the screen of the device.

17. The device of claim 10, wherein the vision object analyzer continuously detects visual objects from the video independently of the input specifying the user query.

18. The device of claim 10, wherein the visual objects stored in the physical memory have been displayed on the screen of the device.

19. A device, comprising:
a screen;
a physical memory; and
a hardware processor capable of performing operations including:
detecting visual objects in a video concurrently with playing the video on the screen of the device;
storing the visual objects within a physical memory of the device and discarding the visual objects from the physical memory after a predetermined window of time;
in response to receiving an input from a user specifying a user query, searching the visual objects stored in the physical memory for a match to the user query;
in response to matching a selected visual object from the physical memory with the user query, submitting the selected visual object with the user query to a large language model system; and
providing a result from the large language model system to the user.

20. The device of claim 19, wherein the video is received by the device in real-time and the screen of the device is incapable of detecting touch-based user input; and
wherein the visual objects stored in the physical memory have been displayed on the screen of the device.
